(19) United States
(12) Patent Application Publication
(10) Pub. No.: US 2026/0252309 A1
(43) Pub. Date: Aug. 27, 2026

(54) METHOD OF GENERATING AN OUTPUT BINARY WORD FROM AN INPUT BINARY WORD, METHOD OF PERFORMING AN ARITHMETIC OPERATION ON AN INPUT BINARY WORD ASSOCIATED TO AN OUTPUT BINARY WORD, CORRESPONDING COMPUTER PROGRAM PRODUCT AND DEVICES

(71) Applicant: NAGRAVISION SÀRL, Cheseaux-sur-Lausanne (CH)

(72) Inventor: Hervé PELLETIER, Cheseaux-sur-Lausanne (CH)

(73) Assignee: NAGRAVISION SÀRL, Cheseaux-sur-Lausanne (CH)

(21) Appl. No.: 19/649,506

(22) Filed: Apr. 16, 2026

Related U.S. Application Data
(63) Continuation of application No. PCT/EP2024/078853, filed on Oct. 14, 2024.

(30) Foreign Application Priority Data
Oct. 16, 2023 (EP) 23203801.8

(51) Int. Cl. G06F 7/487

(52) U.S. Cl. CPC G06F 7/4876; G06F 7/4873

(57) ABSTRACT

A method for generating an output binary word from an input binary word, including: executing a first floating-point multiplication wherein the input binary word interpreted as an integer number is multiplied with a first predetermined floating-point number, resulting in a first floating-point number argument; applying a predetermined invertible function to the first floating-point number argument delivering a first output floating-point number, the output binary word being based on the first output floating-point number. The predetermined invertible function is configured to have the first output floating-point number having a non-null output rounding error resulting in having an application, to the first output floating-point number, of an invert function of the predetermined invertible function that delivers an input floating-point number corresponding to an input operand with a non-null input error.

### CROSS-REFERENCE TO RELATED APPLICATIONS

The present application is related to and claims priority as a bypass continuation of PCT/EP2024/078853, filed Oct. 14, 2024, which claims priority to European Application No. EP23203801.8 filed Oct. 16, 2023. The contents of both of those applications are incorporated herein by reference.

### FIELD OF THE DISCLOSURE

The field of the disclosure is that of countermeasures against side-channel attacks.

More specifically, the disclosure relates to techniques for improving the masking of data.

The disclosure can be of interest in any field wherein the masking of data is of interest. This is the case for instance in the field of cryptography, e.g. for secure communications, for end-to-end encryption (e.g. for the diffusion of content in a pay-TV system), and for storing data (e.g. passwords), etc.

### TECHNOLOGICAL BACKGROUND

In the field of cryptography, to process a non-linear function (e.g. like in AES (for “Advanced Encryption Standard”)) use is made of a substitution table (ST) with pre-computed values instead of recalculating the values of the non-linear function when needed. Furthermore, the binary words in such ST are often interpreted as integer numbers for their processing. All this indeed takes less space on silicon chips and uses less energy than operations performed on the fly.

The usage of such ST is often protected against side-channel attacks by affine masking countermeasures.

For instance, consider x the input number of a given non-linear function and y the output number of the considered non-linear function, the corresponding substitution table ST is such that y=ST(x). Conversely, consider two random numbers M1, M2 as the input and output masks. In the case of Boolean masking countermeasure (e.g. as applied in AES), the masked table MST is defined by MST(x)=ST(x⊕M1)⊕M2, where ⊕ represents the bitwise XOR between the binary representations of the considered arguments. Then MST is used instead of ST to mask the ST(x) values.

Unfortunately, with a deep machine learning approach, it is possible to identify the MST content and the value of the masks M1 and M2 with a certain probability during its creation or during its usage. This approach is feasible because internal data (M1, M2, MST(x)) can be correctly labelled and the total number of possible labels stays low (for an 8-bit binary word only 255 labels are possible).

Moreover, a high order attack can defeat this countermeasure by exploiting leakage on mask M2 and MST(x) according to a correct Hamming weight (HW) leakage model.

There is thus a need for a solution for improving the countermeasures against side-channel attacks, in particular the masking countermeasures.

### SUMMARY

A particular aspect of the present disclosure relates to a method of masking an input binary word as a countermeasure against side-channel attacks by generating an output binary word from the input binary word by an electronic device. According to such method, the electronic device executes:
executing a first floating-point multiplication wherein the input binary word interpreted as an integer number is multiplied with a first predetermined floating-point number, resulting in a first floating-point number argument;
applying a predetermined invertible function to an input floating-point operand based on the first floating-point number argument delivering a first output floating-point number, the output binary word being based on the first output floating-point number.

The predetermined invertible function is configured to have the first floating-point output number have a non-null output rounding error, wherein inputting the first floating-point output number to an invert function of the predetermined invertible function results in an input floating-point number corresponding to the input floating-point operand with a non-null input rounding error.

Thus, the present disclosure proposes a new and inventive solution for improving the masking countermeasures against side-channel attacks.

More particularly, the use of floating-point operations in cooperation with an invertible function that presents non-null rounding errors (e.g. a function with a non-null unit of least precision (ULP) such as a log function) leads to the generation of output floating-point numbers represented by binary words that can exhibit a large Hamming distance (and thus a large Hamming weight) whereas the respective binary words representations of the input arguments represent integer numbers that are close in the meaning of a mathematical norm. In other words, they are integer numbers close to each other. Such decorrelation between the distance of the input integer numbers and the distance between the binary representation of the output floating-points numbers makes it hard to train a deep learning machine. This thus improves the resistance of the masking of the input binary words against side-channel attacks.

In some embodiments, the input binary word is associated to a given binary word and the electronic device executes:
executing a second floating-point multiplication wherein the given binary word interpreted as an integer number is multiplied with a second predetermined floating-point number, resulting in a first intermediate floating-point number;
executing a floating-point subtraction wherein the first intermediate floating-point number is subtracted from the first floating-point number output, resulting in a second floating-point number output.

The output binary word is based on the second output number.

Thus, the decorrelation between the distance of the input integer numbers and the distance between the binary representation of the output floating-point numbers is further improved by the subtraction of the first intermediate floating-point number from the first floating-point number output delivered by the invertible function. This further improves the resistance of the masking of the input binary word against side-channel attacks.

In some embodiments, the electronic device executes:
executing a floating-point addition wherein the first floating-point number argument is added to a third predetermined floating-point number, resulting in a second floating-point number argument.

The input operand being based on the second floating-point number argument.

Thus, the decorrelation between the distance of the input integer numbers and the distance e between the binary representation of the output floating-point numbers is further improved by the addition of the third predetermined floating-point number to the argument of the invertible function. This further improves the resistance of the masking of the input binary word against side-channel attacks.

In some embodiments wherein the input binary word is associated to a given binary word, the input binary word is an element of a table, the given binary word being a function of an index identifying the binary word in the table.

In some embodiments, the given binary word is the result of a bitwise XOR operator between the index expressed as a binary word and a random integer expressed as a binary word.

Thus, the index of the input binary word is masked (or obfuscated).

Another aspect of the present disclosure relates to a method of executing an arithmetic operation taking as an operand an input binary word associated to an output binary word generated by the execution of the method of generating an output binary word from an input binary word discussed above (in any of the embodiments discussed above). According to such method of executing an arithmetic operation, an electronic device executes:
applying the invert function of the predetermined invertible function to a first number which is based on the output binary word interpreted as a floating-point number delivering a second floating-point number;
executing the arithmetic operation taking as operands, on one hand, a second input operand which is based on the second floating-point number and, on the other hand, a third floating-point input operand, resulting in a third floating-point number;
executing a floating-point division wherein the third floating-point number is divided by the first predetermined floating-point number resulting in a fourth floating-point number representative of a result of the predetermined operation taking as operands, on one hand, the input binary word and, on the other hand, the third floating-point input operand divided by the first predetermined floating-point number.

Thus, the result of the arithmetic operation performed on the input binary word is obtained without having to store in memory the value of the input binary word itself. In other words, the fourth floating-point number is obtained without the need of the knowledge of the input binary word. Only the masked value of the input binary word, i.e. the associated output binary word, is used for the derivation of the fourth number which corresponds to the result of the predetermined operation performed on the input binary word.

For instance, the arithmetic operation is an addition or a multiplication. In such cases, the method is thus adapted to perform the additive or multiplicative masking of the input binary word by a number corresponding to the third floating-point input operand divided by the first predetermined floating-point number.

In some embodiments wherein the output binary word is generated by the execution of the floating-point subtraction, the electronic device executes:
executing a floating-point addition wherein the output binary word interpreted as a floating-point number is added to the intermediate number resulting in a third output floating-point number.

The first number is based on the third output floating-point number.

Thus, the arithmetic operation is performed on the input binary word while the resistance of the masking of the input binary word against side-channel attacks is further improved.

In some embodiments wherein the output binary word is generated by the execution of the floating-point addition, the electronic device executes:
executing a floating-point subtraction wherein the third predetermined floating-point number is subtracted from the second number resulting in a fourth output floating-point number.

The second input operand is based on the third output number.

Thus, the arithmetic operation is performed on the input binary word while the resistance of the masking of the input binary word against side-channel attacks is further improved.

In some embodiments, the third floating-point input operand is an integer multiple of the first predetermined floating-point number.

In some embodiments, the arithmetic operation is an addition and the electronic device executes:
taking the integer part of the fourth floating-point number delivering a rounded fourth number;
converting the rounded fourth floating-point number by executing an algorithm for the conversion between additive and Boolean masking.

Thus, the method is also adapted to perform the Boolean masking of the input binary word by another binary word corresponding to the rounding value of the third floating-point input operand divided by the first predetermined floating-point number. In the present case, the Boolean masking of the input binary word is performed using only the masked value of the input binary word, i.e. the associated output binary word, and not the input binary word itself.

Another aspect of the present disclosure relates to a computer program product comprising program code instructions for implementing the above-mentioned method of generating an output binary word from an input binary word (in any of the different embodiments discussed above), when the program is executed on a computer or a processor.

Another aspect of the present disclosure relates to a computer program product comprising program code instructions for implementing the above-mentioned method of executing an arithmetic operation taking as an operand an input binary word associated to an output binary word (in any of the different embodiments discussed above), when the program is executed on a computer or a processor.

Another aspect of the present disclosure relates to an electronic device comprising means configured for executing all or part of the steps of the above-mentioned method of masking an input binary word as a countermeasure against side-channel attacks by generating an output binary word from the input binary word (in any of the different embodiments discussed above). Thus, the features and advantages of this first device are the same as those of the corresponding steps of said method. Therefore, they are not detailed any further.

Another aspect of the present disclosure relates to a second electronic device comprising means configured for executing all or part of the steps of the above-mentioned method of executing an arithmetic operation taking as an operand an input binary word associated to an output binary word (in any of the different embodiments discussed above). Thus, the features and advantages of this second device are the same as those of the corresponding steps of said method. Therefore, they are not detailed any further.

### BRIEF DESCRIPTION OF THE DRAWINGS

Other features and advantages of embodiments shall appear from the following description, given by way of indicative and non-exhaustive examples and from the appended drawings, of which:

FIG. 1 illustrates an output table comprising output binary words resulting in an application of the method of FIG. 2 to the input binary words of an input table according to one embodiment of the present disclosure;

FIG. 2 illustrates a flowchart of a method of generating an output binary word from an input binary word according to one embodiment of the present disclosure;

FIG. 3A illustrates a flowchart of the method of performing an arithmetic operation taking as an operand an input binary word associated to an output binary word generated by the execution of the method of FIG. 2 according to an embodiment of the present disclosure;

FIG. 3B illustrates a flowchart of the method of performing an arithmetic operation taking as an operand an input binary word associated to an output binary word generated by the execution of the method of FIG. 2 according to another embodiment of the present disclosure;

FIG. 4 illustrates an example of the structural blocks of an electronic device allowing steps of the method of FIG. 2 to be executed according to one embodiment of the present disclosure;

FIG. 5 illustrates an example of the structural blocks of an electronic device allowing steps of the method of FIG. 3A or of FIG. 3B to be executed according to one embodiment of the present disclosure.

### DETAILED DESCRIPTION

In all of the figures of the present document, the same numerical reference signs designate similar elements and steps.

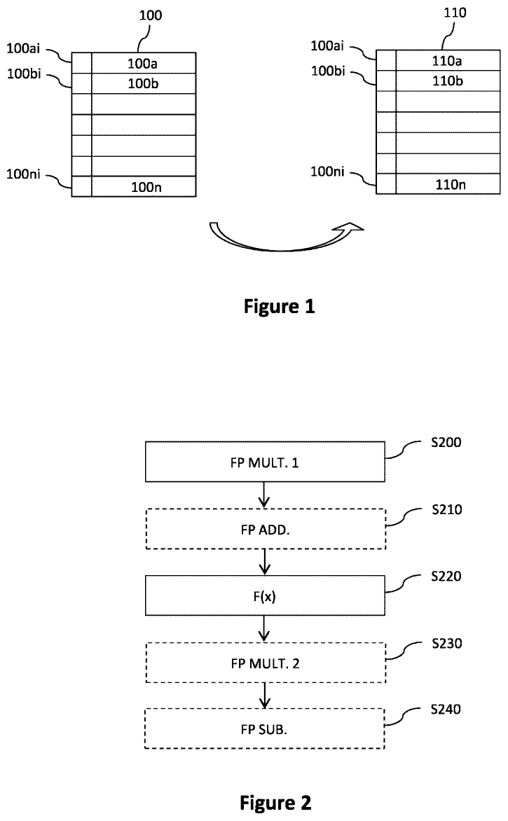

Referring now to FIG. 1, we illustrate an output table 110 comprising output binary words 110a, 110b, . . . , 110n resulting of an application of the method of FIG. 2 to the input binary words 100a, 100b, . . . , 100n of an input table 100 according to one embodiment of the present disclosure.

More particularly, the input binary words 100a, 100b, . . . , 100n of the input table 100 are identified by a respective index 100ai, 100bi, . . . , 100ni.

Each of the output binary words 110a, 110b, . . . , 110n of the output table 110 results in the application of the method of FIG. 2 to a respective input binary word 100a, 100b, . . . , 100n. As such, a given output binary word 110a or 110b or . . . or 110n is identified in the output table 110 by the same index 100ai or 100bi or . . . or 100ni as the respective input binary word 100a or 100b or . . . or 100n the given output binary word 110a or 110b or . . . or 110n according to one embodiment of the invention.

For instance, the input table 100 is a substitution table ST and the output table 110 is the masked table MST resulting from the application of the method of FIG. 2 to the input binary words 100a, 100b, . . . , 100n of the input table 100.

Referring now to FIG. 2, we describe the steps of a method of generating an output binary word 110a or 110b or . . . or 110n from an input binary word 100a or 100b or . . . or 100n by an electronic device 400 according to one embodiment of the present disclosure.

More particularly, in a step S200, the electronic device 400 executes a first floating-point multiplication wherein the input binary word 100a or 100b or . . . or 100n interpreted as an integer number is multiplied with a first predetermined floating-point number β, resulting in a first floating-point number argument.

More particularly, the input binary word 100a or 100b or . . . or 100n is identified in the input table 100 by an index i. In the present embodiment, the input binary word 100a or 100b or . . . or 100n is associated to a given binary word function of the index i. For instance, the given binary word results of a bitwise XOR operator between the index i expressed as a binary word and a random integer r expressed as a binary word, resulting in a masked (or obfuscated) index i⊕r. Thus, the index 100ai or 100bi or . . . or 100ni identifying the input binary word is masked. In this case, the input binary word 100a or 100b or . . . or 100n is the element of the input table 100, considered to be a substitution table ST as an example, labelled in the following:

$$ST ( i ⊕ r )$$

where:
i is the binary word representing an index in the input table 100;
r is the binary word representing the random integer; and
⊕ is the bitwise XOR operator.

The first floating-point number argument is thus expressed as:

$$β * ST ( i ⊕ r )$$

In a step S210, the electronic device 400 executes a floating-point addition wherein the first floating-point number argument number β*ST(i⊕r) is added to a third predetermined floating-point number γ, resulting in a second floating-point number argument. The second floating-point number argument is thus expressed as:

$$β * ST ( i ⊕ r ) + γ$$

In a step S220, the electronic device 400 applies a predetermined invertible function ƒ to the second floating-point number argument delivering a first floating-point number output. The first floating-point number output is thus expressed as:

$$f ( β * ST ( i ⊕ r ) + γ )$$

More particularly, the predetermined invertible function ƒ is configured to have the first floating-point number output having a non-null output rounding error, e.g. compared to the expected theoretical value for ƒ. This is for instance due to the rounding errors in the processing with numbers represented on a finite number of bits. This results in having an application, to the first floating-point number output ƒ(β*ST(i⊕r)+γ), of an invert function ƒ⁻¹ of the predetermined invertible function ƒ that delivers an input floating-point number corresponding to the argument β*ST(i⊕r)+γ plus a non-null input error. In other words, the application of the invert function ƒ⁻¹ to the first floating-point number output does not allow recovering exactly the original argument ƒ(β*ST(i⊕r)+γ).

Indeed, the use of floating-point operations in cooperation with an invertible function that presents non-null rounding errors (e.g. a function with a non-null “unit of least precision” (ULP), such as a log function) leads to the generation of output floating-point numbers represented by binary words that can exhibit a large Hamming distance (and thus a large Hamming weight) whereas the respective binary words representations of the input arguments represent integer numbers that are close in the meaning of a mathematical norm. In other words, they are integer numbers close to each other. Such decorrelation between the distance of the input integer numbers and the distance between the binary representation of the output floating-points numbers makes hard to train a deep learning machine. This thus improves the resistance of the masking of the input binary words against side-channel attacks.

In a step S230, the electronic device 400 executes a second floating-point multiplication. More particularly, the masked index i⊕r interpreted as an integer number is multiplied with a second predetermined floating-point number α, resulting in a first intermediate floating-point number α*(i⊕r).

In a step S240, the electronic device 400 executes a floating-point subtraction wherein the first intermediate floating-point number α*(i⊕r) is subtracted from the first floating-point number output ƒ(β*ST(i⊕r)+γ), resulting in a second floating-point number output expressed as:

$$f ( β * ST ( i ⊕ r ) + γ ) - α * ( i ⊕ r )$$

Thus, the decorrelation between the distance of the input integer numbers and the distance between the binary representation of the output floating-points numbers is further improved by the subtraction of the first intermediate floating-point number from the first floating-point number output delivered by the invertible function. This further improves the resistance of the masking of the input binary word against side-channel attacks.

In the present embodiment, the output binary word is the binary representation of the second output number

$$f ( β * ST ( i ⊕ r ) + γ ) - α * ( i ⊕ r ) .$$

However, in some embodiments, no random integer r is used for masking the index i. In such embodiments, the first intermediate floating-point number is expressed as α*i.

In some embodiments the step S210 is not executed. In some of those embodiments, the first floating-point number output number is thus expressed as ƒ(β*ST(i⊕r)) and the output binary word is the binary representation of the second floating-point number output given by ƒ(β*ST(i⊕r))−α*(i⊕r) or ƒ(β*ST(i⊕r))−α*i. This makes the implementation simpler. However, the use of the third predetermined number γ during the execution of the step S210 improves the decorrelation between the distance of the input integer numbers and the distance between the binary representation of the output floating-points numbers. This further improves the resistance of the masking of the input binary word against side-channel attacks.

In some embodiments, the method of FIG. 2 applies to an input binary word which is not an element of a table. In such case, the input binary word is an arbitrary binary word IBW comprising a predetermined number of bits. In some of those embodiments, the first floating-point number output is expressed as ƒ(β*IBW) and the output binary word is the binary representation of the second floating-point number output ƒ(β*IBW)−α*(i⊕r) or ƒ(β*IBW)−α*i, with i being a predetermined binary word. In other of those embodiments, the first floating-point number output is expressed as ƒ(β*IBW+γ) and the output binary word is the binary representation of the second floating-point number output ƒ(β*IBW+γ)−α*(i⊕r) or ƒ(β*IBW+γ)−α*i, with i being a predetermined binary word.

In some embodiments the steps S230 and S240 are not executed. In some of those embodiments wherein the first floating-point number output thus expressed as ƒ(β*ST(i⊕r)), the output binary word is the binary representation of the second floating-point number output ƒ(β*ST(i⊕r)). In other of those embodiments wherein the first floating-point number output is expressed as ƒ(β*IBW), the output binary word is the binary representation of the second floating-point number output ƒ(β*IBW). This makes the implementation simpler even if the use of the second predetermined floating-point number α during the execution of the step S210 improves the decorrelation between the distance of the input integer numbers and the distance between the binary representation of the output floating-points numbers.

In some embodiments, the first predetermined floating-point number β and/or the second predetermined floating-point number α and/or the third predetermined floating-point number γ is a number selected randomly. This further improves the resistance of the masking of the input binary words against side-channel attacks.

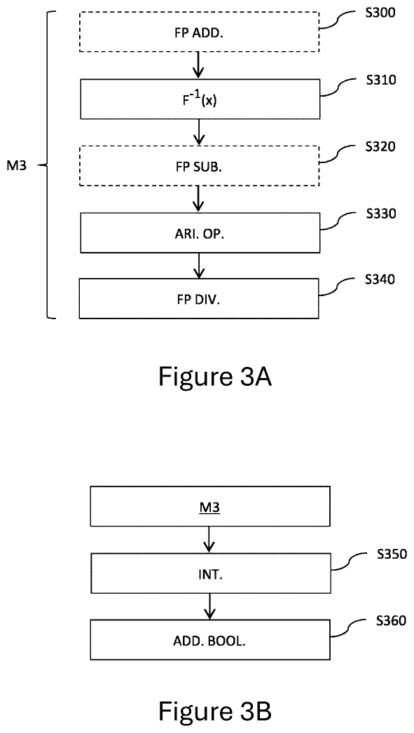

Referring now to FIG. 3A, the steps of a method of performing an arithmetic operation taking as an operand an input binary word 100a or 100b or . . . or 100n associated to an output binary word 110a or 110b or . . . or 110n according to one embodiment of the present disclosure are described. Such arithmetic operation is, for example, an addition or a multiplication.

More particularly, the output binary word 110a or 110b or . . . or 110n has been generated by the execution of the method of FIG. 2. According to the embodiment of FIG. 2, the output binary word 110a or 110b or . . . or 110n is thus expressed as the binary representation of the second floating-point number output

$$f ( β * ST ( i ⊕ r ) + γ ) - α * ( i ⊕ r ) .$$

Accordingly, in a step S300, an electronic device 500 executes a floating-point addition wherein the output binary word interpreted as a floating-point number is added to a first intermediate floating-point number α*(i⊕r) resulting in a first floating-point reconstructed number OP1. In the present embodiment, the first floating-point reconstructed number OP1 is thus expressed as:

$$f ( β * ST ( i ⊕ r ) + γ )$$

In a step S310, the electronic device 500 applies the invert function ƒ⁻¹ of the predetermined invertible function ƒ to the first floating-point reconstructed number OP1 delivering a second floating-point reconstructed number OP2. In the present embodiment, the second floating-point reconstructed number OP2 is thus expressed as:

$$β * ST ( i ⊕ r ) + γ$$

In a step S320, the electronic device 500 applies a floating-point subtraction wherein the third predetermined number γ is subtracted from the second floating-point reconstructed number OP2 resulting in a third reconstructed floating-point number. In the present embodiment, third reconstructed floating-point number is thus expressed as:

$$β * ST ( i ⊕ r )$$

In a step S330, the electronic device 500 executes an arithmetic operation taking as operands, on one hand, the third reconstructed floating-point number and, on the other hand, a reconstruction floating-point input operand μ, resulting in a fourth floating-point reconstructed number OP4. For instance, when the arithmetic operation is an addition, the fourth floating-point reconstructed number OP4 is expressed as:

$$β * ST ( i ⊕ r ) + µ$$

Conversely, when the arithmetic operation is a multiplication, the fourth floating-point reconstructed number OP4 is expressed as:

$$β * ST ( i ⊕ r ) + µ$$

Back to FIG. 3A, in a step S340, the electronic device 500 executes a floating-point division wherein the fourth floating-point reconstructed number OP4 is divided by the first predetermined floating-point number β resulting in a fifth floating-point reconstructed number OP5 representative of a result of the predetermined operation taking as operands, on one hand, the input binary word ST(i⊕r) and, on the other hand, the reconstruction floating-point input operand μ divided by the first predetermined floating-point number β. For instance, when the arithmetic operation is an addition, the fifth floating-point reconstructed number OP5 is expressed as:

$$ST ( i ⊕ r ) + µ / β$$

Conversely, when the arithmetic operation is a multiplication, the fifth floating-point reconstructed number OP5 is expressed as:

$$ST ( i ⊕ r ) * µ / β$$

Thus, the result of the arithmetic operation performed on the input binary word ST(i⊕r) is obtained without having to store in memory the value of the input binary word ST(i⊕r) itself. In other words, the fifth floating-point reconstructed number OP5 is obtained without the need of the knowledge of the input binary word ST(i⊕r). Only the masked value of the input binary word, i.e. the associated output binary word which is the binary representation of the number ƒ(β*ST(i⊕r)+γ)−α*(i⊕r), is used for the derivation of the fifth floating-point reconstructed number OP5. For instance, when the arithmetic operation is an addition (respectively a multiplication), the method is thus adapted to perform the additive (respectively the multiplicative) masking of the input binary word ST(i⊕r) by a number corresponding to the reconstruction floating-point input operand μ divided by the first predetermined floating-point number β.

In some embodiments, the reconstruction floating-point input operand μ is an integer multiple of the first predetermined floating-point number β. Thus, when the arithmetic operation is e.g. an addition, the fifth floating-point reconstructed number OP5 corresponds to the addition of an integer number to the input binary word ST(i⊕r). When the arithmetic operation is e.g. a multiplication, the fifth floating-point reconstructed number OP5 corresponds to the multiplication of the input binary word ST(i⊕r) by an integer number.

In the embodiment of FIG. 3A, the output binary word 110a or 110b or . . . or 110n has been generated by the execution of the method of FIG. 2 and is thus considered as the binary representation of the number ƒ(β*ST(i⊕r)+γ)−α*(i⊕r).

However, in some embodiments discussed above in relation with FIG. 2, no random integer r is used for masking the index i. In such embodiments, during the step S300, the first intermediate floating-point number is expressed as α*i which is added to the output binary word interpreted as a floating-point.

In some embodiments discussed above in relation with FIG. 2 wherein the step S210 is not executed, the output binary word is the binary representation of the number ƒ(β*ST(i⊕r))−α*(i⊕r), or ƒ(β*ST(i⊕r))−α*i, In such embodiments, the step S320 is not executed as the second floating-point reconstructed number OP2 is e.g. directly

$$f ( β * ST ( i ⊕ r ) ) .$$

In some embodiments discussed above in relation with FIG. 2, the input binary word is not an element of a table but is an arbitrary binary word IBW comprising a predetermined number of bits. In some of those embodiments, the output binary word is the binary representation of the number e.g. as ƒ(β*IBW)−α*(i⊕r) or as ƒ(β*IBW)−α*i, with i being a predetermined binary word. In such embodiments, the step S320 is not executed as the second number OP2 is e.g. directly ƒ(β* IBW).

In some embodiments discussed above in relation with FIG. 2 wherein the steps S230 and S240 are not executed, the output binary word is expressed e.g. as the binary representation of the number ƒ(β*ST(i⊕r)) or as ƒ(β*IBW). In such embodiments, the step S300 is not executed as the first floating-point reconstructed number OP1 is e.g. directly ƒβ*ST(i⊕r)) or

$$f ( β * IBW ) .$$

Referring now to FIG. 3B, we describe the steps of a method of performing an arithmetic operation taking as an operand an input binary word 100a or 100b or . . . or 100n associated to an output binary word 110a or 110b or . . . or 110n according to another embodiment of the present disclosure.

More particularly, in the present embodiment, the method of performing an arithmetic operation comprises a combination of all or part of the steps S300, S310, S320, S330 and S340 according to any one of the various embodiments described above in relation with FIG. 2. Such combination is executed during a phase M3.

However, according to the embodiment of FIG. 3B, the arithmetic operation is an addition and the third floating-point input operand μ is an integer multiple of the first predetermined floating-point number β, i.e. μ=k*β with k an integer.

After the execution of the phase M3, in a step S350, the electronic device 500 takes the integer part of the fifth floating-point reconstructed number OP5 delivering a rounded part of the fifth floating-point reconstructed number OP5. Depending on the implementation, the rounded part of fifth floating-point reconstructed number OP5 can be expressed e.g. as └ST(i⊕r)┘+k or └IBW┘+k. with └.┘ that denotes the integer part (e.g. the floor function).

In a step S360, the electronic device 500 converts the rounded part of fifth floating-point reconstructed number OP5 by executing an algorithm for the conversion between additive and Boolean masking.

Such algorithm is e.g. an algorithm as disclosed in the article by Jean-Sebastien Coron, Johann Großschädl, Mehdi Tibouchi, and Praveen Kumar Vadnala: “Conversion from Arithmetic to Boolean Masking with Logarithmic Complexity”.

Thus, the present method is also adapted to perform the Boolean masking of the input binary word, ST(i⊕r) or IBW, by another binary word corresponding to the rounding value of the reconstruction floating-point input operand μ divided by the first predetermined floating-point number β. In the present case, the Boolean masking of the input binary word is performed using only the masked value of the input binary word, i.e. the associated output binary word, and not the input binary word itself.

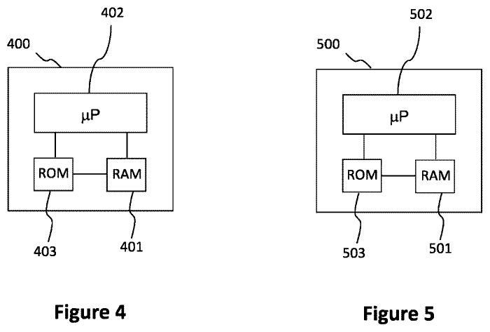

Referring now to FIG. 4, in order to be able to implement the corresponding steps of the method of generating an output binary word from an input binary word in the various embodiments disclosed above in relationship with FIG. 2, in some embodiments the electronic device 400 comprises:
a non-volatile memory 403 (e.g. a read-only memory (ROM), a hard disk, a flash memory, etc.);
a volatile memory 401 (e.g. a random-access memory or RAM) and a processor 402.

The non-volatile memory 403 is a non-transitory computer-readable carrier medium. It stores executable program code instructions, which are executed by the processor 402 in order to enable implementation of some steps of the method described above (method of generating an output binary word from an input binary word) in the various embodiments disclosed above in relationship with FIG. 2.

Upon initialization, the aforementioned program code instructions are transferred from the non-volatile memory 403 to the volatile memory 401 so as to be executed by the processor 402. The volatile memory 401 likewise includes registers for storing the variables and parameters required for this execution.

The steps of the method of generating an output binary word from an input binary word may be implemented equally well using circuitry:
by the execution of a set of program code instructions executed by a reprogrammable computing machine such as a PC type apparatus, a DSP (digital al signal processor) or a microcontroller. These program code instructions can be stored in a non-transitory computer-readable carrier medium that is detachable (for example a CD-ROM, a DVD-ROM, a USB key) or non-detachable; or
by a dedicated machine or component, such as an FPGA (Field Programmable Gate Array), an ASIC (Application-Specific Integrated Circuit) or any dedicated hardware component.

In other words, the disclosure is not limited to a purely software-based implementation, in the form of computer program instructions, but that it may also be implemented in hardware form or any form combining a hardware portion and a software portion.

Referring now to FIG. 5, in order to be able to implement the corresponding steps of the method of performing an arithmetic operation on an input binary word associated to an output binary word in the various embodiments disclosed above in relationship with FIG. 3A and FIG. 3B, in some embodiments the electronic device 500 comprises:
a non-volatile memory 503 (e.g. a read-only memory (ROM), a hard disk, a flash memory, etc.);
a volatile memory 501 (e.g. a random-access memory or RAM) and a processor 502.

The non-volatile memory 503 is a non-transitory computer-readable carrier medium. It stores executable program code instructions, which are executed by the processor 502 in order to enable implementation of some steps of the method described above (method of performing an arithmetic operation on an input binary word associated to an output binary word) in the various embodiments disclosed above in relationship with FIG. 3A and FIG. 3B.

Upon initialization, the aforementioned program code instructions are transferred from the non-volatile memory 503 to the volatile memory 501 so as to be executed by the processor 502. The volatile memory 501 likewise includes registers for storing the variables and parameters required for this execution.

The steps of the method of performing an arithmetic operation on an input binary word associated to an output binary word may be implemented equally well using circuitry:
by the execution of a set of program code instructions executed by a reprogrammable computing machine such as a PC type apparatus, a DSP (digital signal processor) or a microcontroller. These program code instructions can be stored in a non-transitory computer-readable carrier medium that is detachable (for example a CD-ROM, a DVD-ROM, a USB key) or non-detachable; or
by a dedicated machine or component, such as an FPGA (Field Programmable Gate Array), an ASIC (Application-Specific Integrated Circuit) or any dedicated hardware component.

In other words, the disclosure is not limited to a purely software-based implementation, in the form of computer program instructions, but that it may also be implemented in hardware form or any form combining a hardware portion and a software portion.

In some embodiments, the electronic device 400 and/or the electronic device 500 is implemented in a set top box or in a gateway.

In some embodiments, the electronic device 400 and the electronic device 500 are a same device.

Additional configurations of portions of the present invention are described in the parentheticals provided below:
(1) A method, performed by an electronic device (400), of masking an input binary word as a countermeasure against side-channel attacks by generating an output binary word (110a, 110b, . . . , 110n) from the input binary word (100a, 100b, . . . , 100n) including, but not limited to, the steps of: executing a first floating-point multiplication (S200) wherein the input binary word interpreted as an integer number is multiplied with a first predetermined number of floating-point type, resulting in a first argument number of floating-point type; and applying a predetermined invertible function (S220) to an input operand based on the first argument number delivering a first output number, wherein the input operand and the first output number are of the floating-point type, the output binary word being based on the first output number, wherein the predetermined invertible function is configured to have the first output number having a non-null output rounding error, wherein inputting the first output number to an invert function of the predetermined invertible function results in an input number of the floating-point type corresponding to the input operand with a non-null input rounding error.
(2) The method according to (1), wherein the input binary word is associated to a given binary word, and wherein the method performed by the electronic device further includes, but is not limited to: executing a second floating-point multiplication (S230) wherein the given binary word interpreted as an integer number is multiplied with a second predetermined number of a floating-point type, resulting in an intermediate number of the floating-point type; and executing a floating-point subtraction (S240) wherein the intermediate number is subtracted from the first output number, resulting in a second output number of the floating-point type, wherein the output binary word is based on the second output number.
(3) The method according to either one of (1) or (2), wherein the method performed by the electronic device further includes, but is not limited to: executing a floating-point addition (S210) wherein the first argument number is added to a third predetermined number of the floating-point type, resulting in a second argument number of the floating-point type, wherein the input operand being based on the second argument number.
(4) The method according to either one of (2) or (3) in that it depends on (2), wherein the input binary word is an element of a table (100), said given binary word being a function of an index (100ai, 100bi, . . . , 100ni) identifying the binary word in the table.
(5) The method according to (4), wherein said given binary word is the result of a bitwise XOR operator between the index expressed as a binary word and a random integer expressed as a binary word.
(6) A method, performed by an electronic device (500), of executing an arithmetic operation taking as an operand an input binary word (100a, 100b, . . . , 100n) associated to an output binary word (110a, 110b, . . . , 110n) generated by the method according to any of (1)-(5), including, but not limited to: applying the invert function (S310) of the predetermined invertible function to a first number which is based on the output binary word interpreted as a floating-point number delivering a second number of the floating-point type; executing the arithmetic operation (S330) taking as operands, on one hand, a second input operand which is based on the second number and, on the other hand, a third floating-point input operand, resulting in a third number; and executing a floating-point division (S340) wherein the third number is divided by the first predetermined number resulting in a fourth number representative of a result of the predetermined operation taking as operands, on one hand, the input binary word and, on the other hand, the third floating-point input operand divided by the first predetermined floating-point number.
(7) The method, performed by the electronic device of (6), wherein the output binary word is generated by the method according to (2) or according to any one of (3)-(5) that depends on (2), wherein the method further includes, but is not limited to: executing a floating-point addition (S300) wherein the output binary word interpreted as a floating-point number is added to the intermediate number resulting in a third output number of the floating-point type, and wherein the first number is based on the third output number.
(8) The method, performed by the electronic device of (6), according to either one of (6) or (7), wherein the output binary word is generated by method according to (3) or according to either one of (4) or (5) that depends on (3), wherein the method further includes, but is not limited to: executing a floating-point subtraction (S320) wherein the third predetermined number is subtracted from the second number resulting in a fourth output number of the floating-point type, and wherein the second input operand is based on the third output number.
(9) The method according to any one of (6)-(8), wherein the third floating-point input operand is an integer multiple of the first predetermined number.
(10) The method according to (9), wherein the arithmetic operation is an addition,
and wherein the method further includes, but is not limited to:
   taking the integer part (S350) of the fourth number delivering a rounded fourth number; and converting the rounded fourth number (S360) by executing an algorithm for the conversion between additive and Boolean masking.
(11) A computer program product characterized in that it comprises program code instructions for implementing a method according to any one of (1)-(5), when said program is executed on a computer or a processor.
(12) A computer program product characterized in that it comprises program code instructions for implementing a method according to any one of (6)-(10), when said program is executed on a computer or a processor.
(13) A device (400) for masking an input binary word as a countermeasure against side-channel attacks by generating an output binary word (110a, 110b, . . . , 110n) from the input binary word (100a, 100b, . . . , 100n), the device (400) including, but not limited to: a processor (402) or a dedicated computing machine configured for: executing a first floating-point multiplication (S200) wherein the input binary word interpreted as an integer number is multiplied with a first predetermined number of floating-point type, resulting in a first argument number of floating-point type; and applying a predetermined invertible function (S220) to an input operand based on the first argument number delivering a first output number, wherein the input operand and the first output number are of the floating-point type, the output binary word being based on the first output number, wherein the predetermined invertible function is configured to have the first output number having a non-null output rounding error, wherein inputting the first output number to an invert function of the predetermined invertible function results in an input number of the floating-point type corresponding to the input operand with a non-null input rounding error.
(14) A device (400) for masking an input binary word as a countermeasure against side-channel attacks by generating an output binary word (110a, 110b, . . . , 110n) from the input binary word (100a, 100b, . . . , 100n), the device including, but not limited to: a processor (402) or a dedicated computing machine configured to perform the method of any one of (1)-(5).
(15) A device (500) for performing an arithmetic operation taking as an operand an input binary word (100a, 100b, . . . , 100n) associated to an output binary word (110a, 110b, . . . , 110n) generated by the execution of the method according to any one of (1)-(5), the device (500) including, but not limited to: a processor (502) or a dedicated computing machine configured for: applying the invert function (S310) of the predetermined invertible function to a first number which is based on the output binary word interpreted as a floating-point number delivering a second number of the floating-point type; executing the arithmetic operation (S330) taking as operands, on one hand, a second input operand which is based on the second number and, on the other hand, a third floating-point input operand, resulting in a third floating-point number; executing a floating-point division (S340) wherein the third number is divided by the first predetermined number resulting in a fourth number representative of a result of the predetermined operation taking as operands, on one hand, the input binary word and, on the other hand, the third floating-point input operand divided by the first predetermined floating-point number.
(16) A device (500) for performing an arithmetic operation taking as an operand an input binary word (100a, 100b, . . . , 100n) associated to an output binary word (110a, 110b, . . . , 110n) generated by the execution of the method according to any one of (1)-(5), the device (500) including, but not limited to: a processor (502) or a dedicated computing machine configured to perform the steps of the method of any one of (6-10).

1. A method of masking an input binary word as a countermeasure against side-channel attacks by generating an output binary word from the input binary word, the method comprising:
executing, by an electronic device, a first floating-point multiplication wherein the input binary word interpreted as an integer number is multiplied with a first predetermined floating-point number, resulting in a first floating-point number argument; and
applying, by the electronic device, a predetermined invertible function to a floating-point input operand based on the first floating-point argument delivering a first output floating-point number, the output binary word being based on the first output floating-point number,
wherein the predetermined invertible function is configured to have the first output floating-point number having a non-null output rounding error, and
wherein inputting the first output floating-point number to an invert function of the predetermined invertible function results in an input floating-point number corresponding to the floating-point input operand with a non-null input rounding error.

2. The method according to claim 1, wherein the input binary word is associated to a given binary word, the method further comprising:
executing, by the electronic device, a second floating-point multiplication wherein the given binary word interpreted as an integer number is multiplied with a second predetermined floating-point number, resulting in an intermediate floating-point number;
executing, by the electronic device, a floating-point subtraction wherein the intermediate floating-point number is subtracted from the first output floating-point number, resulting in a second output floating-point number, the output binary word being based on the second output floating-point number.

3. The method according to claim 1, further comprising:
executing, by the electronic device, a floating-point addition wherein the first floating-point number argument is added to a third predetermined floating-point number, resulting in a second floating-point number argument number, and
wherein the floating-point input operand being based on the second floating-point number argument.

4. The method according to claim 2, wherein the input binary word is an element of a table, said given binary word being a function of an index identifying the binary word in the table.

5. The method according to claim 4, wherein said given binary word is the result of a bitwise XOR operator between the index expressed as a binary word and a random integer expressed as a binary word.

6. A method performed by an electronic device of recovering an input binary word masked as a countermeasure against side-channel attacks, the method comprising:
applying an invert function of a predetermined invertible function to a first floating-point reconstructed number to produce a second floating-point reconstructed number;
performing a floating-point arithmetic operation based on a reconstruction floating-point input operand and the second floating-point reconstructed number to produce a third floating-point reconstructed number; and
performing a floating-point division on the third floating-point reconstructed number to produce a fourth reconstructed floating-point number corresponding to the recovered input binary word masked as a countermeasure against side-channel attacks.

7. The method according to claim 6, further comprising performing a floating-point addition to add an intermediate floating-point number to a first floating-point number to produce the first floating-point reconstructed number, wherein the intermediate floating-point number is based on a first predetermined floating-point number.

8. The method according to claim 6, wherein performing the floating-point arithmetic operation based on the reconstruction floating-point input operand and the second floating-point reconstructed number to produce the third floating-point reconstructed number comprises performing the floating-point arithmetic operation based on the reconstruction floating-point input operand and a result of subtracting a first predetermined floating-point number from the second floating-point reconstructed number to produce the third floating-point reconstructed number.

9. The method according to claim 7, wherein performing the floating-point arithmetic operation based on the reconstruction floating-point input operand and the second floating-point reconstructed number to produce the third floating-point reconstructed number comprises performing the floating-point arithmetic operation based on the reconstruction floating-point input operand and a result of subtracting a second predetermined floating-point number from the second floating-point reconstructed o produce the third floating-point reconstructed number.

10. The method according to claim 6, wherein the floating-point arithmetic operation is a floating-point addition.

11. The method according to claim 6, wherein the floating-point arithmetic operation is a floating-point multiplication.

12. The method according to claim 6, further comprising obtaining a rounded portion of the fourth reconstructed floating-point number to produce the recovered input binary word masked as a countermeasure against side-channel attacks.

13. An electronic device for masking an input binary word as a countermeasure against side-channel attacks by generating an output binary word from the input binary word, the electronic device comprising:
electronic circuitry configured to:
execute a first floating-point multiplication wherein the input binary word interpreted as an integer number is multiplied with a first predetermined floating-point number, resulting in a first floating-point number argument; and
apply a predetermined invertible function to a floating- point input operand based on the first floating-point argument delivering a first output floating-point number, the output binary word being based on the first output floating-point number,
wherein the predetermined invertible function is configured to have the first output floating-point number have a non-null output rounding error, and
wherein inputting the first output floating-point number to an invert function of the predetermined invertible function results in an input floating-point number corresponding to the floating-point input operand with a non-null input rounding error.

14. An electronic device for recovering an input binary word masked as a countermeasure against side-channel attacks, the electronic device comprising:
electronic circuitry configured to:
apply an invert function of a predetermined invertible function to a first floating-point reconstructed number to produce a second floating-point reconstructed number;
perform a floating-point arithmetic operation based on a reconstruction floating-point input operand and the second floating-point reconstructed number to produce a third floating-point reconstructed number; and
perform a floating-point division on the third floating-point reconstructed number to produce a fourth reconstructed floating-point number corresponding to the recovered input binary word masked as a countermeasure against side-channel attacks.
